(19) United States
(12) Patent Application Publication
(10) Pub. No.: US 2008/0028013 A1
(43) Pub. Date: Jan. 31, 2008

(54) TWO-DIMENSIONAL FAST FOURIER TRANSFORM CALCULATION METHOD AND APPARATUS

(75) Inventors: Hideki Kamegawa, Tokyo (JP); Masahiko Sakurai, Gunma (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 11/865,792

(22) Filed: Oct. 2, 2007

(30) Foreign Application Priority Data
Nov. 1, 1996 (JP) 2006-297638

(51) Int. Cl. G06F 17/14

(52) U.S. Cl. 708/400

(57) ABSTRACT

A two-dimensional fast Fourier transform is carried out on a block of sample points by executing a one-dimensional fast Fourier transform on all vertical lines of sample points, storing the resulting values at one or more specified positions in each vertical line in an internal buffer, and then executing a one-dimensional fast Fourier transform on each resulting horizontal line of transformed data. This entire process is repeated, the specified positions being changed at each repetition, until all horizontal lines have been processed. The necessary amount of buffer memory is reduced because the internal buffer only has to store intermediate results for a limited number of horizontal lines.

### BACKGROUND OF THE INVENTION

1. Field of the Invention

The present invention relates to a method of calculating a two-dimensional fast Fourier transform in a semiconductor integrated circuit, and to a circuit implementing the method.

2. Description of the Related Art

The two-dimensional fast Fourier transform (FFT) is widely used in image processing and for other purposes. As shown in FIG. 1, an image 11 is generally divided into a number of sub-areas 12, and a two-dimensional FFT is carried out on each sub-area separately. Image data for a sub-area 12 are stored in a memory 1 as shown in FIG. 2, and the two-dimensional FFT is carried out by a two-dimensional FFT calculation apparatus 300 including a vertical one-dimensional FFT calculation circuit 301, a horizontal one-dimensional FFT calculation circuit 302, and an internal buffer 303. The vertical one-dimensional FFT calculation circuit 301 is interfaced to the memory 1 by a memory interface 304, and to the internal buffer 303 by an intermediate buffer interface 305; the horizontal one-dimensional FFT calculation circuit 302 is interfaced to the memory 1 by a memory interface 307, and to the internal buffer 303 by an intermediate buffer interface 306.

Referring to FIG. 3, the vertical one-dimensional FFT calculation circuit 301 comprises an access control circuit 311 connected to the memory interface 304 and intermediate buffer interface 305, an FFT circuit 312, and a data bus 313. In the vertical one-dimensional FFT calculation circuit 301, when the access control circuit 311 receives an FFT start signal Ss, it reads the data for one vertical line in a sub-area from the memory 1 through the memory interface 3041 sends the FFT circuit 312 a data ready signal Sr311, and sends the read data D304 to the FFT circuit 312 on the data bus 313. The FFT circuit 312 performs a one-dimensional FFT on the read data D304 and, then sends a one-dimensional FFT completion signal Sd312 to the access control circuit 311. The access control circuit 311 responds by retrieving first transformed data D305 for the one vertical line from the FFT circuit 312 the FFT circuit 312 via the data bus 313 and writes the first transformed data into the internal buffer 303 via the intermediate buffer interface 305. The vertical one-dimensional FFT calculation circuit 301 continues to generate first transformed data D305 in this way for each vertical line and write the transformed data into the internal buffer 303 until all vertical lines in the sub-area have been transformed, at which point the access control circuit 311 sends the horizontal one-dimensional FFT calculation circuit 302 a vertical FFT completion signal Sd.

Referring to FIG. 4, the horizontal one-dimensional FFT calculation circuit 302 comprises an access control circuit 321 connected to the memory interface 307 and intermediate buffer interface 306, an FFT circuit 322, and a data bus 323. When the access control circuit 321 receives the vertical FFT completion signal Sd from the vertical one-dimensional FFT calculation circuit 301, it reads data for one horizontal line from the first transformed data stored in the internal buffer 303 through the intermediate buffer interface 306, sends the FFT circuit 322 a data ready signal Sr321, and sends the read data D306 to the FFT circuit 322 on the data bus 323. The FFT circuit 322 performs a one-dimensional FFT on the read data D306, and then sends a one-dimensional FFT completion signal Sd322 to the access control circuit 321. The access control circuit 321 responds by retrieving the resulting second transformed data D307 for the one horizontal line from the FFT circuit 322 via the data bus 323 and writing the second transformed data into the memory 1 via memory interface 307. The horizontal one-dimensional FFT calculation circuit 302 continues to generate second transformed data in this way for each horizontal line and write the transformed data into the memory 1 until all horizontal lines in the sub-area have been transformed, at which point the two-dimensional FFT is complete and the access control circuit 311 outputs a two-dimensional FFT completion signal Sdf.

This procedure is illustrated in flowchart and diagram form FIGS. 5 and 6. In the two-dimensional FFT calculation apparatus 300, the vertical one-dimensional FFT calculation circuit 301 reads data for one vertical line in a sub-area from the memory 1 (step ST301), performs a one-dimensional FFT on the one vertical line (step ST302), and writes the resulting first transformed data into the internal buffer 303 (step ST303). This flow is repeated thirty-two times (step ST304) which corresponds to the number of data points in the horizontal direction of the sub-area 12. Subsequently, the horizontal one-dimensional FFT calculation circuit 302 reads data for one horizontal line from the first transformed data stored in the internal buffer 303 (step ST305), performs a one-dimensional FFT on the one horizontal line (step ST306), and writes the resulting second transformed data into the memory 1 (step ST307). This flow is repeated thirty-two times (step ST308) which corresponds to the number of data points in the vertical direction of the sub-area 12. A two-dimensional FFT for one sub-area 12 having 1024 data points arranged in 32 vertical lines and 32 horizontal lines is thus completed by the processes in steps ST301 to st308. Next, the same processes are repeated for another sub-area.

When the two-dimensional FFT is performed on a series of sub-areas 112, the processing time can be speeded up by having the vertical one-dimensional FFT calculation circuit 301 process a sub-area while the horizontal one-dimensional FFT calculation circuit 302 is processing the preceding sub-area (that is, the vertical FFT and horizontal FFT are pipelined). To implement this pipeline processing, a second internal buffer is needed, so that the vertical one-dimensional FFT calculation circuit 301 can write to one buffer while the horizontal one-dimensional FFT calculation circuit 302 reads from the other buffer. Internal buffer space equivalent to 32 vertical lines×32 horizontal lines×2 planes is accordingly required.

A description of a conventional multi-dimensional Fourier transform can be found in, for example, Japanese Patent Application Publication No. 2002-163247.

The conventional two-dimensional FFT calculation apparatus described above, however, requires an internal buffer 303 having at least enough space to store data for one sub-area 12 in the image 11, for example, at least 32 lines×32 lines×1 plane. When the processing is pipelined, the buffer space requirement is at least 32 lines×32 lines×2 planes. In either case, the internal buffer 303 takes up considerable space in the two-dimensional FFT calculation apparatus 300, thereby increasing the size and accordingly the cost of the integrated circuit in which the two-dimensional FFT calculation apparatus 300 is used.

An attendant problem is that the size of the sub-areas 112 in the image 11 is limited by the size of the internal buffer 303. If a comparatively small internal buffer is provided to save space in the integrated circuit, the two-dimensional FFT calculation apparatus 300 can be used only to process comparatively small sub-areas.

When pipeline processing is not adopted, the size of the two-dimensional FFT calculation apparatus 300 can be reduced by using the same FFT circuit for both the horizontal and vertical FFT processing, so that only one FFT circuit is required, but one internal buffer plane is still required, so the buffer-space problems described above still remain.

An alternative method of saving space is to eliminate the internal buffer and write the vertical one-dimensional FFT calculation results into an external general-purpose memory. While this has the advantage of providing potentially unlimited buffer space, it raises the problem of access contention, because the FFT circuit may have to compete with other circuits, such as a central processing unit (CPU) in the integrated circuit, for access to the external memory. Consequently, the FFT calculations cannot be reliably completed within a specified time.

### SUMMARY OF THE INVENTION

An object of the present invention is to provide a method and apparatus for performing a two-dimensional FFT with less internal buffer space than is conventionally required.

The invention provides a method of executing a two-dimensional FFT on first data representing a two-dimensional array of sample points arranged in first lines extending in a first (e.g., vertical) direction intersected by second lines extending in a second (e.g., horizontal) direction.

In a first step, a one-dimensional FFT is executed on the first data for each first line to generate first transformed data. The first transformed data for a predetermined number of specified positions in each first line are selected and stored in an internal buffer, so that the internal buffer holds first transformed data for the predetermined number of second lines. The predetermined number is less than the number of sample points per first line.

In a second step, a one-dimensional FFT is performed on the first transformed data stored in the internal buffer to obtain second transformed data for the first predetermined number of second lines, and the second transformed data are output.

The first and second steps are repeated with different specified positions until the one-dimensional FFT has been performed on all second lines.

The predetermined number is preferably an integer that evenly divides the number of sample points per first line. The predetermined number may be equal to one.

This method can be practiced with less internal buffer space than conventionally required because the internal buffer only has to store first transformed data for the predetermined number of second lines.

### BRIEF DESCRIPTION OF THE DRAWINGS

In the attached drawings:

FIG. 1 shows an exemplary sub-area in an exemplary image;

FIG. 2 is a block diagram showing the general structure of a conventional two-dimensional FFT circuit;

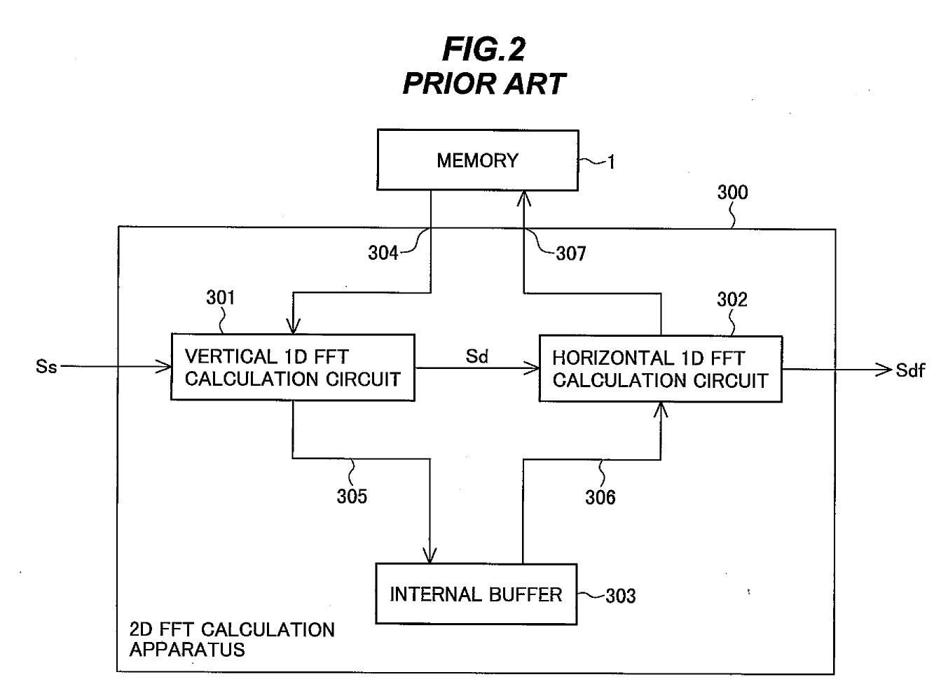

FIG. 3 is a more detailed block diagram showing the internal structure of the vertical one-dimensional FFT calculation circuit in FIG. 2;

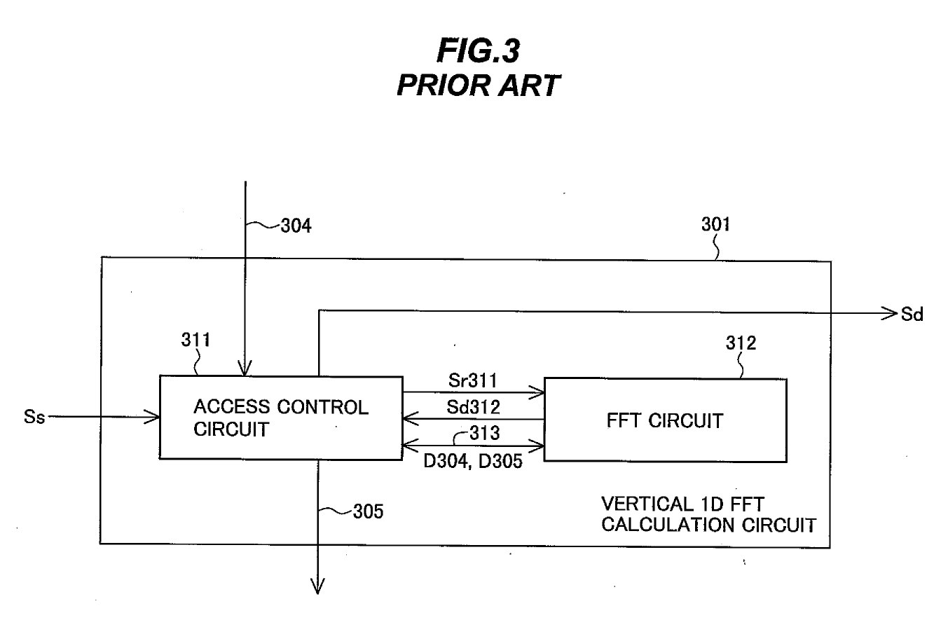

FIG. 4 is a more detailed block diagram showing the internal structure of the horizontal one-dimensional FFT calculation circuit in FIG. 2;

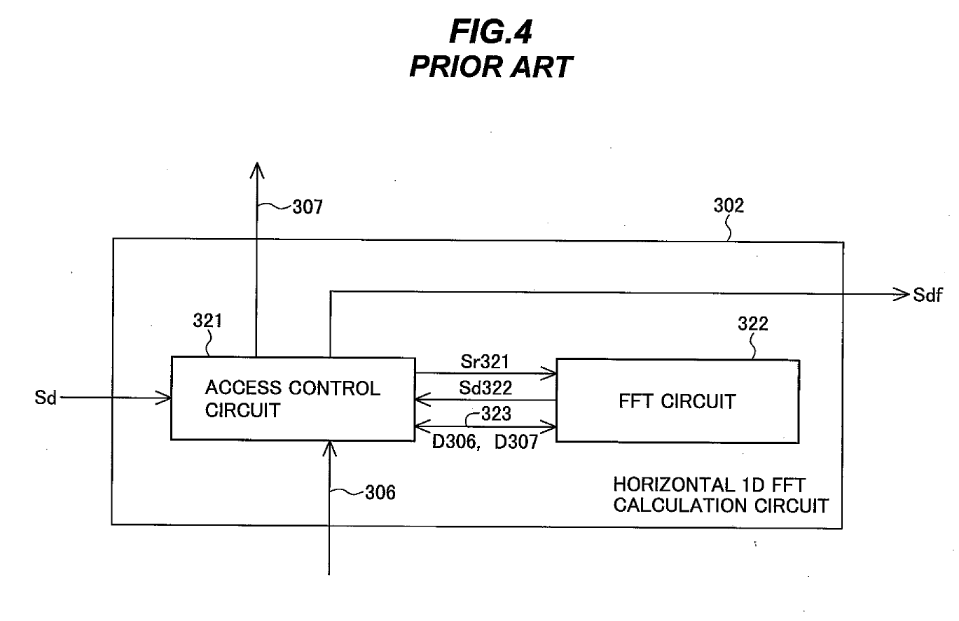

FIG. 5 is a flowchart of the operation of the conventional two-dimensional FFT circuit;

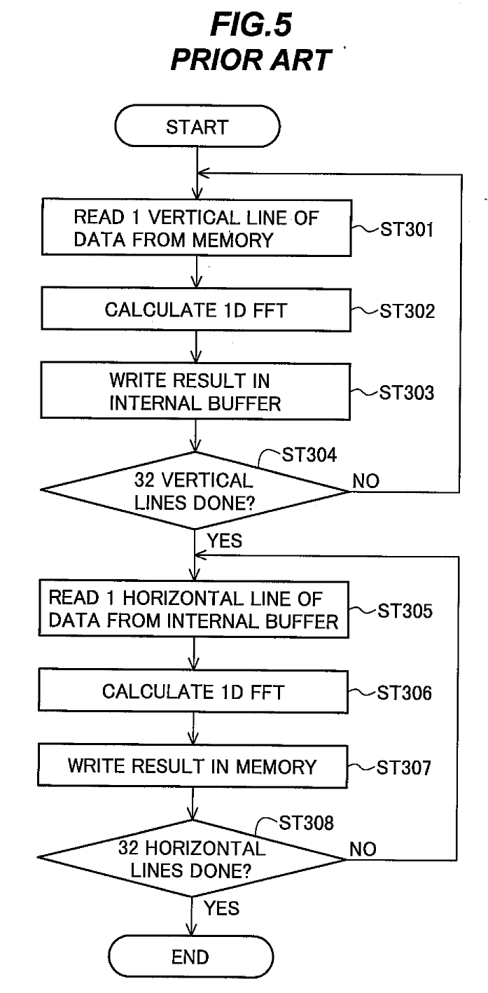

FIG. 6 is a diagram depicting the operation of the conventional two-dimensional FFT circuit;

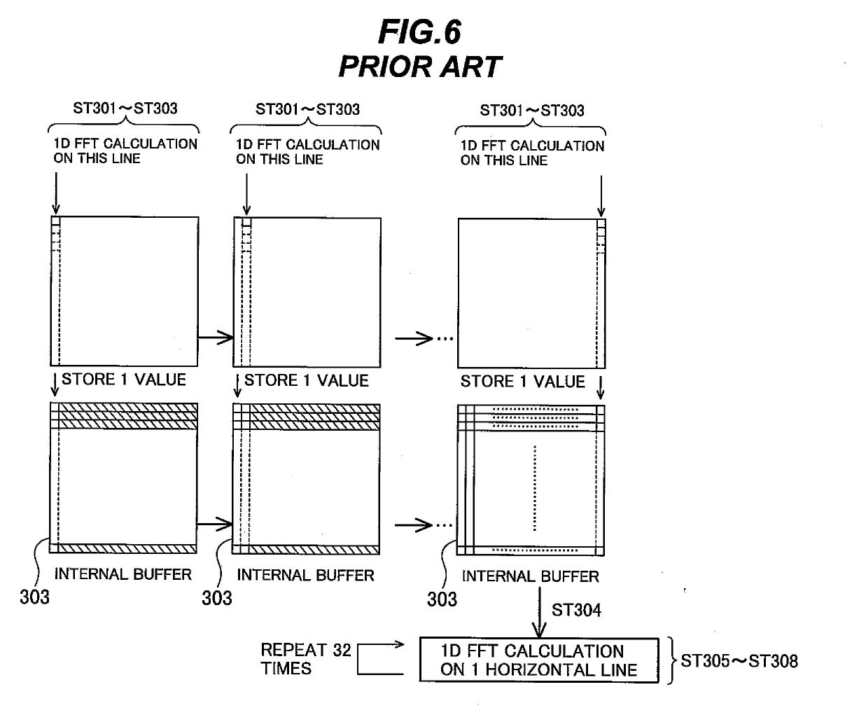

FIG. 7 is a block diagram showing the general structure of a two-dimensional FFT circuit according to a first embodiment of the invention;

FIG. 8 is a more detailed block diagram showing the internal structure of the vertical one-dimensional FFT calculation circuit in FIG. 7;

FIG. 9 is a more detailed block diagram showing the internal structure of the horizontal one-dimensional FFT calculation circuit in FIG. 7;

FIG. 10 is a flowchart of the operation of the two-dimensional FFT circuit in FIG. 7;

FIG. 11 is a diagram depicting the operation of the two-dimensional FFT circuit in FIG. 7;

FIG. 12 is a block diagram showing the general structure of a two-dimensional FFT circuit according to a second embodiment of the invention;

FIG. 13 is a more detailed block diagram showing the internal structure of the vertical one-dimensional FFT calculation circuit in FIG. 12;

FIG. 14 is a more detailed block diagram showing the internal structure of the horizontal one-dimensional FFT calculation circuit in FIG. 12;

FIG. 15 is a flowchart of the operation of the two-dimensional FFT circuit in FIG. 12; and

FIG. 16 is a diagram depicting the operation of the two-dimensional FFT circuit in FIG. 12.

### DETAILED DESCRIPTION OF THE INVENTION

Embodiments of the invention will now be described with reference to the attached drawings, in which analogous elements are indicated by analogous reference characters.

### First Embodiment

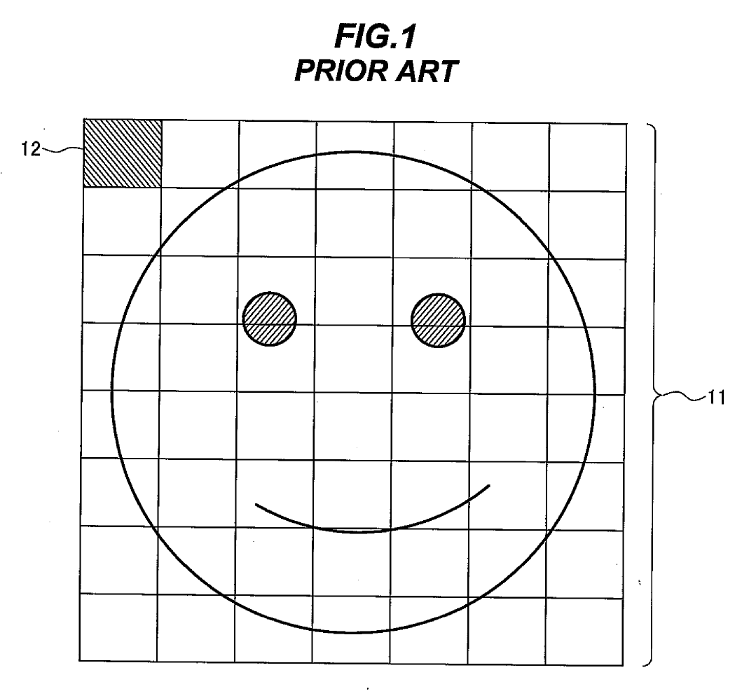

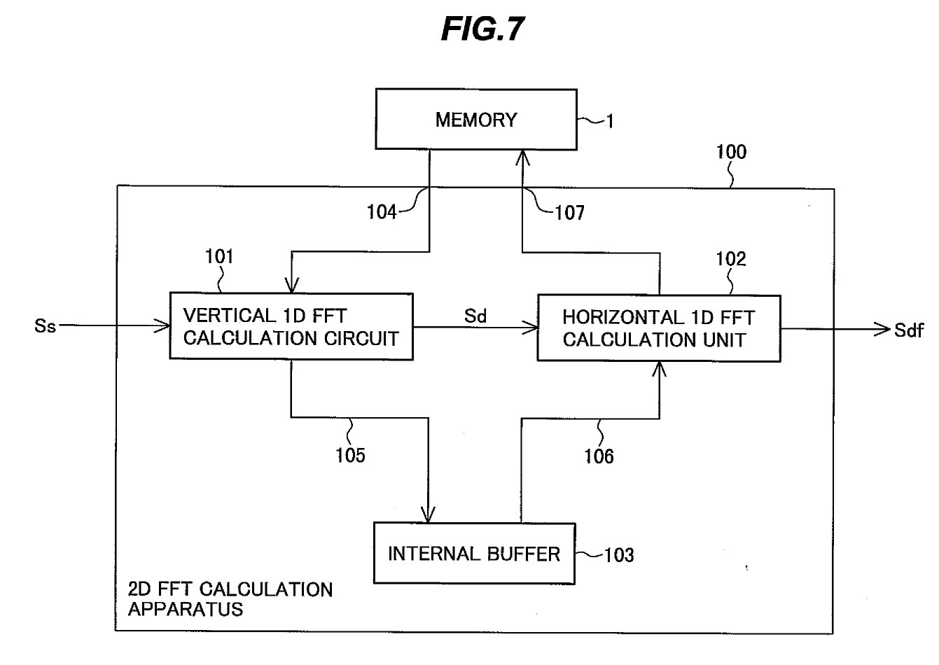

Referring to FIG. 7, a two-dimensional FFT calculation apparatus 100 according to a first embodiment of the invention has the same general structure as the conventional circuit described above: a vertical one-dimensional FFT calculation circuit 101 and a horizontal one-dimensional FFT calculation circuit 102 are interfaced through a pair of memory interfaces 104, 107 to a memory 1 storing the data to be processed, and through a pair of intermediate buffer interfaces 105, 106 to an internal buffer 103. The data stored in the memory 1 represent, for example, the sub-areas 12 in FIG. 1, each comprising data for 1024 sample points (pixels) arranged in thirty-two horizontal lines and thirty-two vertical lines.

It will be appreciated that the invention is not limited to the processing of 32×32-pixel sub-areas of images like the one in FIG. 1.

The internal buffer 103 in the first embodiment has enough space to store data for the number of sample points pixels in one horizontal line in a sub-area (sub-area 12 in FIG. 1): for example, space for thirty-two data values, representing the intersections of thirty-two vertical lines with one horizontal line in one plane. If the two-dimensional FFT calculation apparatus 100 is pipelined, the internal buffer 103 has twice this amount of space: for example, space for storing sixty-four data values (corresponding to 32 vertical lines×1 horizontal line×2 planes).

The vertical one-dimensional FFT calculation circuit 101 executes a one-dimensional FFT on the data for each vertical line in a sub-area to generate first transformed data. The first transformed data for a predetermined number of specified positions in each vertical line are selected and stored in the internal buffer 103, so that the internal buffer 103 holds first transformed data for the predetermined number of horizontal lines. The predetermined number is less than the number of sample points per vertical line and is equal to one in the first embodiment.

Upon completing the above processing, the vertical one-dimensional FFT calculation circuit 101 sends the horizontal one-dimensional FFT calculation circuit 102 a vertical FFT completion signal Sd. The horizontal one-dimensional FFT calculation circuit 102 performs a one-dimensional FFT on the first transformed data for the one horizontal line stored in the internal buffer 103 to generate second transformed data for the one horizontal line, and stores second transformed data in the memory 1.

The vertical one-dimensional FFT calculation circuit 101 and horizontal one-dimensional FFT calculation circuit 102 repeat the above processing with different specified positions in each vertical line until the one-dimensional FFT has been performed on all horizontal lines, at which point the two-dimensional FFT is complete.

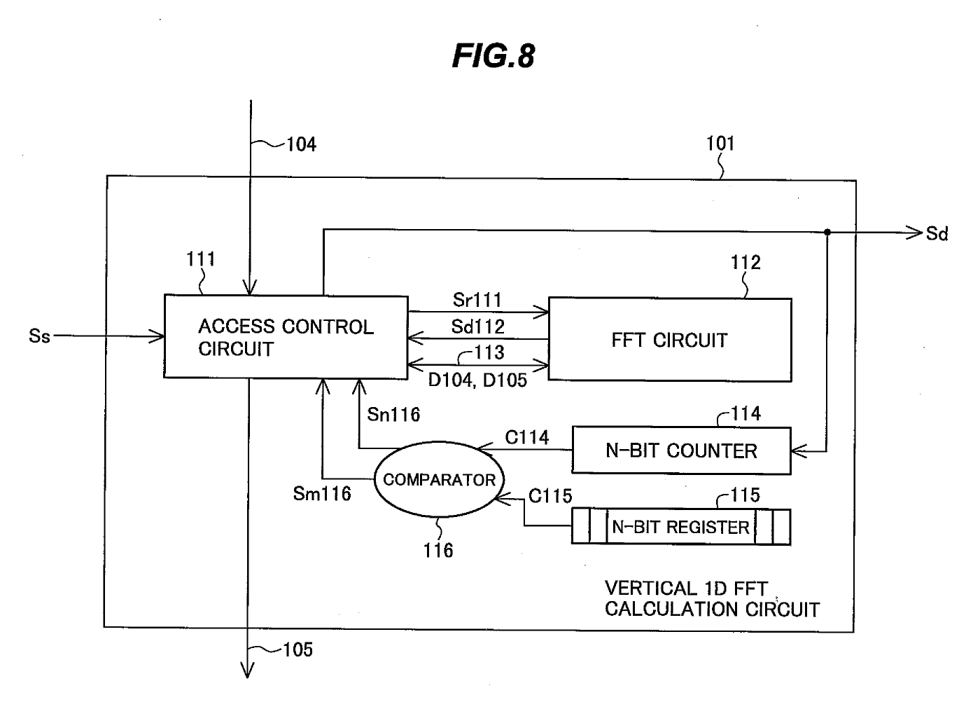

Referring to FIG. 8, the vertical one-dimensional FFT calculation circuit 101 comprises an access control circuit 111 connected to the memory interface 104 and intermediate buffer interface 105, an FFT circuit 112, a data bus 113 interconnecting the access control circuit 111 and the FFT circuit 112, an N-bit counter 114, an N-bit register 115, and a comparator 116.

When the access control circuit 111 receives an FFT start signal Ss, it reads the data for one vertical line in a sub-area from the memory 1 through the memory interface 104, sends the FFT circuit 112 a data ready signal Sr111, and sends the read data D104 to the FFT circuit 112 on the data bus 113.

The FFT circuit 112 performs a one-dimensional FFT on the read data D104 and, upon the completion of this transform, sends a one-dimensional FFT completion signal Sd112 to the access control circuit 111. When the access control circuit 111 receives the one-dimensional FFT completion signal Sd112, it retrieves at least part of the resulting transformed data D105 for the one vertical line from the FFT circuit 112 via the data bus 113 and writes one transformed data value into the internal buffer 103 via the intermediate buffer interface 105 as first transformed data. The position of this value in the transformed data generated by the FFT circuit 122 will be denoted M, where M is a non-negative integer.

The access control circuit 111 and FFT circuit 112 perform these operations on all vertical lines in the sub-area, using the same value of M; then the access control circuit 111 outputs the vertical FFT completion signal Sd. At this point the internal buffer 103 holds one horizontal line (the M-th line) of first transformed data.

The N-bit counter 114 is an up-counter that counts occurrences of the vertical FFT completion signal Sd and outputs a count value C114. N is a positive integer large enough for the N-bit counter 114 to count up to at least the number of horizontal lines per sub-area.

The N-bit register 115 stores and outputs a value C115 corresponding to the number of sample points (pixels) per vertical line in the sub-area. For a 32×32-pixel sub-area, the N-bit register 115 stores the value ‘32’.

The comparator 116 compares the count value C114 output by the N-bit counter 114 with the value C115 stored in the N-bit register 115. If the compared data match, the comparator 116 asserts a match signal Sm116. Otherwise, the comparator 116 asserts a mismatch signal Sn116.

In response to either the match signal Sm116 or the mismatch signal Sn116, the access control circuit 111 begins rereading successive vertical lines of data from the memory 1. When the mismatch signal Sn116 is asserted, the access control circuit 111 increments M by one and rereads the data for the same sub-area, in order to obtain a new horizontal line of first transformed data. When the match signal Sm116 is asserted, the access control circuit 111 resets M to zero and starts reading data for a new sub-area.

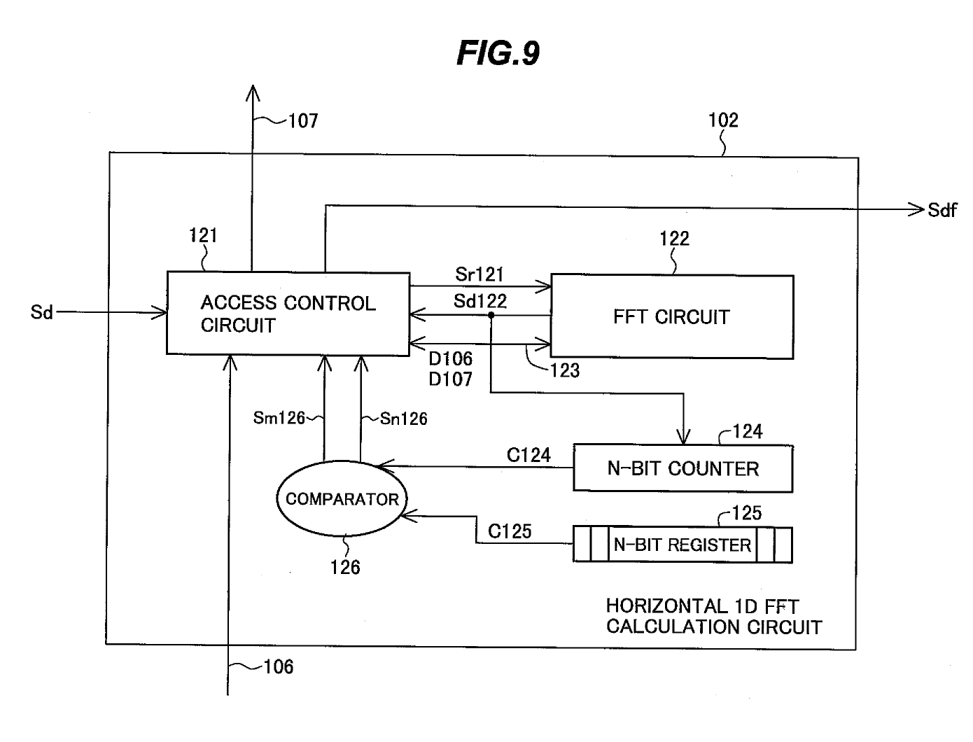

Referring to FIG. 9, the horizontal one-dimensional FFT calculation circuit 102 comprises an access control circuit 121 connected to the memory interface 107 and intermediate buffer interface 106, an FFT circuit 122, a data bus 123 interconnecting the access control circuit 121 and the FFT circuit 122, an N-bit counter 124, an N-bit register 125, and a comparator 126.

When the access control circuit 121 receives the vertical FFT completion signal Sd, it reads the data for one horizontal line from the internal buffer 103 through the intermediate buffer interface 106, sends the FFT circuit 122 a data ready signal Sr121, and sends the read data D106 to the FFT circuit 122 on the data bus 123.

The FFT circuit 122 executes a horizontal one-dimensional FFT on the data D106 read from the internal buffer 103 and, upon the completion of this transform, sends a one-dimensional FFT completion signal Sd122 to the access control circuit 121. When the access control circuit 121 receives the one-dimensional FFT completion signal Sd122, it retrieves all of the resulting second transformed data D107 via the data bus 123 and writes the second transformed data for the one horizontal line into the memory 1 via the memory interface 107 as two-dimensional FFT output data for the M-th horizontal line.

The N-bit counter 124 is an up-counter that counts occurrences of the horizontal one-dimensional FFT completion signal Sd122 and outputs a count value C124.

The N-bit register 125 stores and outputs a value C125 corresponding to the number of horizontal lines per sub-area. For a 32×32-pixel sub-area, the N-bit register 115 stores the value ‘32’.

The comparator 126 compares the count value C124 output by the N-bit counter 124 with the value C125 stored in the N-bit register 125. If the compared data match, the comparator 126 asserts a match signal Sm126. Otherwise, the comparator 126 asserts a mismatch signal Sn126.

When the mismatch signal Sn126 is asserted, the access control circuit 121 takes no particular action but simply waits for the next vertical FFT completion signal Sd from the vertical one-dimensional FFT calculation circuit 101. (If the value of M is held separately in the two access control circuits 111, 121, however, access control circuit 121 increments its internally held M value at this point.) When the match signal Sm126 is asserted, the access control circuit 121 outputs a two-dimensional FFT completion signal Sdf (and resets M to zero if necessary).

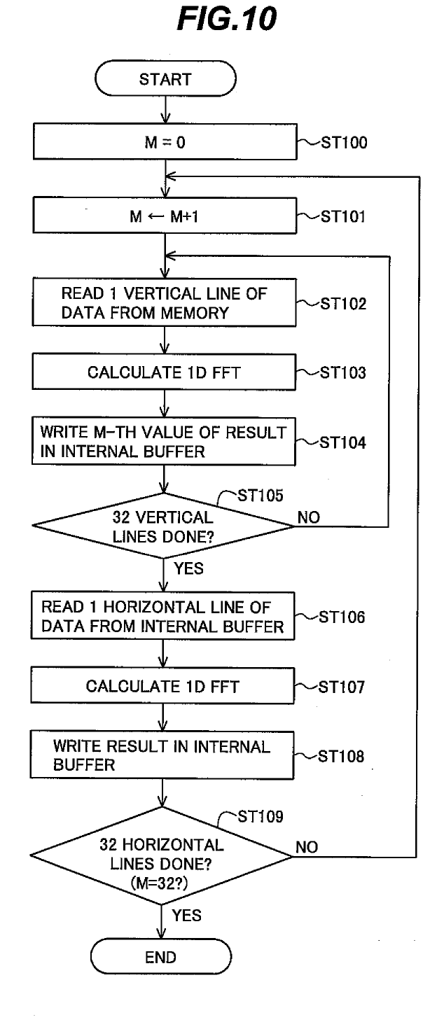

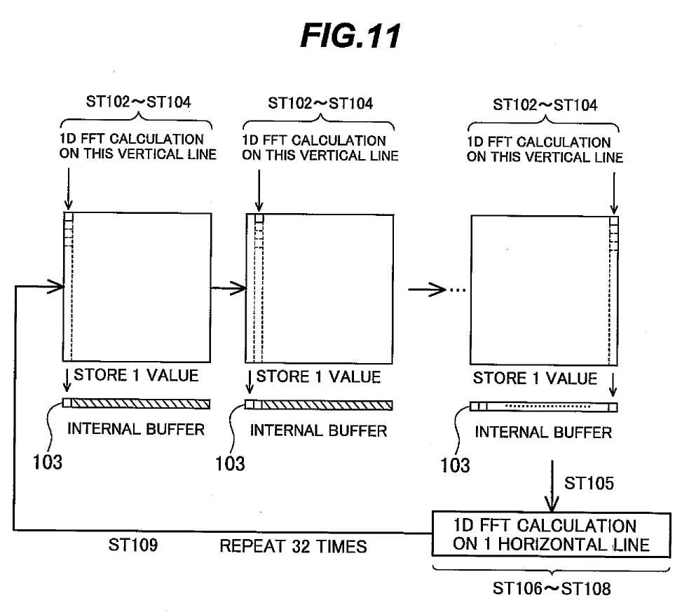

The operation of the two-dimensional FFT calculation apparatus 100 in the first embodiment will be described with reference to FIGS. 10 and 11.

As shown in FIG. 10, to begin the processing of a sub-area, the vertical one-dimensional FFT calculation circuit 101 initializes the number M to zero (step ST100) and then increments M by one (step ST101). Next, the data for one vertical line in the sub-area are read from the memory 1 (step ST102) and a one-dimensional FFT is executed on the read data to generate first transformed data (step ST103), after which the M-th transformed data value (in this case, M=1) is selected from the first transformed data and written into the internal buffer 103 (step ST104). Next, the vertical one-dimensional FFT calculation circuit 101 executes the processes in steps ST102 to ST104 again repeatedly until these processes have been repeated thirty-two times (corresponding to the number of vertical lines in the sub-area 12), changing the vertical line each time (step ST105). At the end of these repetitions, the internal buffer 103 holds thirty-two values representing one horizontal line of first transformed data.

Next, the horizontal one-dimensional FFT calculation circuit 102 reads the first transformed data from the internal buffer 103 (step ST106), executes a one-dimensional FFT on the one horizontal line (step ST107), and writes the resulting thirty-two values of second transformed data into the memory 1 (step ST108).

Next, the vertical one-dimensional FFT calculation circuit 101 and horizontal one-dimensional FFT calculation circuit 102 repeat the processes in steps ST101 to ST108 for the second to thirty-second horizontal lines (M=2 to 32), making thirty-two repetitions in total (step ST109). At the end of these repetitions, the memory 1 holds second transformed data for a matrix of data points arranged in thirty-two vertical and thirty-two horizontal lines. This completes the two-dimensional FFT for one sub-area 12.

The above process can be speeded up by allowing the vertical one-dimensional FFT calculation circuit 101 to carry out steps ST102 and ST013 on the first vertical line of data read from the memory 1 while the horizontal one-dimensional FFT calculation circuit 102 is carrying out steps ST106 and ST107 on the horizontal line of data stored in the internal buffer 103. When the two-dimensional FFT is carried out on a series of sub-areas, while the horizontal one-dimensional FFT calculation circuit 102 is processing the last horizontal line for one sub-area, the vertical one-dimensional FFT calculation circuit 101 may process the first vertical line in the next sub-area.

The two-dimensional FFT calculation apparatus 100 according to the first embodiment (or the equivalent two-dimensional FFT calculation method) requires only 1/H-th as much internal buffer space as the conventional amount, where H is the number of horizontal lines per sub-area. For a 32×32 sub-area, the necessary amount of internal buffer space is reduced by a factor of thirty-two.

Because of this reduced buffer space requirement, the two-dimensional FFT calculation apparatus 100 according to the first embodiment can be used to process sub-areas of a size that would be impractically large with the conventional two-dimensional FFT calculation apparatus.

Although the first embodiment requires more than the conventional amount of computation, because the same vertical FFT computations are carried out repeatedly, these computations can be carried out very quickly by dedicated hardware circuits such as the vertical one-dimensional FFT calculation circuit 101, and since a dedicated internal buffer is used, the entire two-dimensional FFT calculation can be completed within a constant time, as there are no other circuits that contend for access to the buffer.

### Second Embodiment

The second embodiment differs from the first embodiment in that each time a vertical line is processed, two first transformed data values are written into the internal buffer. That is, whereas the first embodiment only saves the first transformed data for an M-th point, the second embodiment saves the first transformed for M1-th and M2-th points. This reduces the necessary number of repetitions of the vertical FFT calculations, as described below.

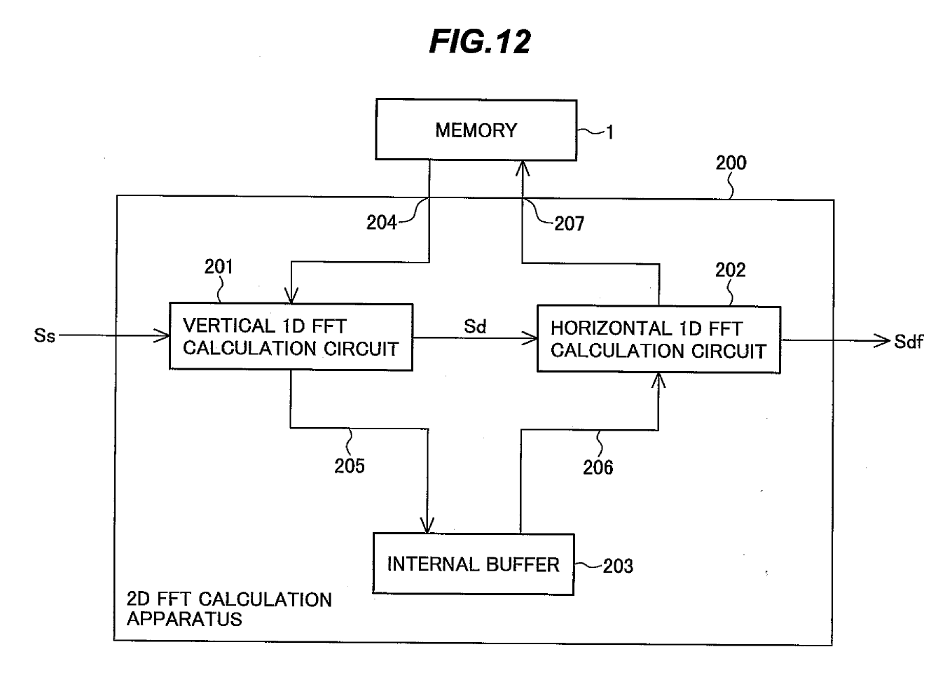

Referring to FIG. 12, the two-dimensional FFT calculation apparatus 200 comprises a vertical one-dimensional FFT calculation circuit 201, a horizontal one-dimensional FFT calculation circuit 202, an internal buffer 203, a pair of memory interfaces 204, 207, and a pair of intermediate buffer interfaces 205, 206. The vertical one-dimensional FFT calculation circuit 201 and horizontal one-dimensional FFT calculation circuit 202 are interfaced through the pair of memory interfaces 204, 207 to the memory 1, and through the pair of intermediate buffer interfaces 205, 206 to the internal buffer 203. The vertical one-dimensional FFT calculation circuit 201 and horizontal one-dimensional FFT calculation circuit 202 perform one-dimensional fast Fourier transforms on the data for vertical and horizontal lines, respectively. The internal buffer 203 in the second embodiment has enough buffer space to store data for the number of sample points in two horizontal lines in a sub-area, for example, data for sixty-four points (corresponding to 32 vertical lines×2 horizontal lines).

The vertical one-dimensional FFT calculation circuit 201 executes a one-dimensional FFT on the data for each vertical line in a sub-area to generate first transformed data. The first transformed data for a predetermined number of specified positions in each vertical line are selected and stored in the internal buffer 203. These operations are repeated until the internal buffer 203 holds first transformed data for the predetermined number of complete horizontal lines.

The predetermined number is less than the number of sample points per vertical line and is equal to two (M1, M2) in the second embodiment. The predetermined number is not limited to two, however; it may be any integer (for example, four) that evenly divides the number of sample points per vertical line in the sub-area. The first embodiment can be regarded as a special case of the second embodiment in which the predetermined number is one.

When the first transformed data for the M1-th and M2-th horizontal lines have been stored into the internal buffer 203 by the vertical one-dimensional FFT calculation circuit 201, the horizontal one-dimensional FFT calculation circuit 202 performs a one-dimensional FFT on the first transformed data for each of the two horizontal lines stored in the internal buffer 203 to generate the second transformed data for the two horizontal lines, and stores the second transformed data in the memory 1.

The vertical one-dimensional FFT calculation circuit 201 and horizontal one-dimensional FFT calculation circuit 202 repeats the above processing with different specified positions (different values of M1 and M2) until the one-dimensional FFT has been performed on all horizontal lines, at which point the two-dimensional FFT is complete.

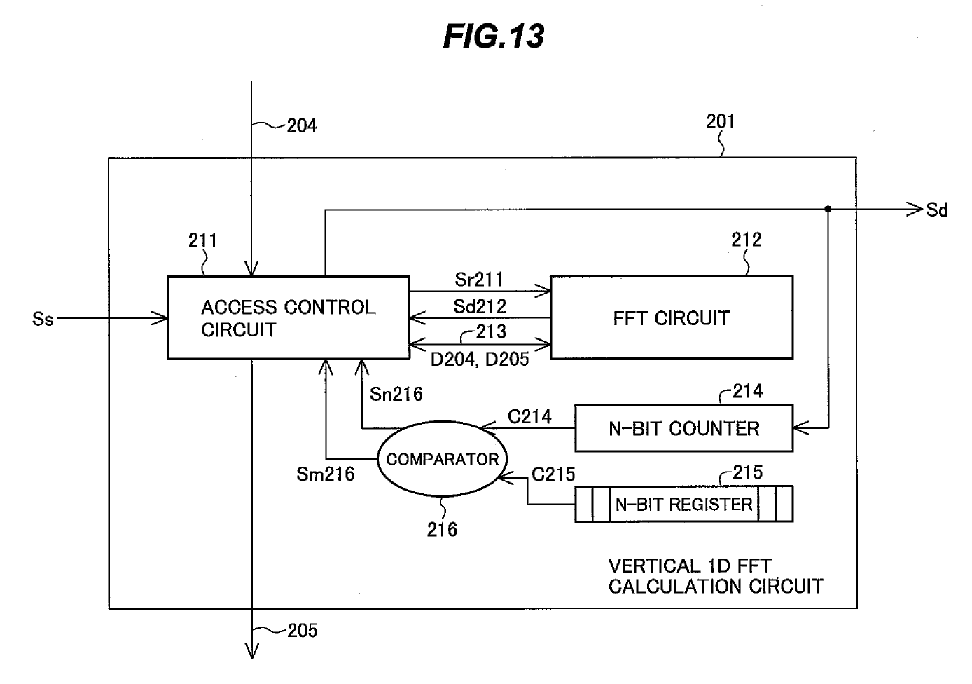

Referring to FIG. 13, the vertical one-dimensional FFT calculation circuit 201 comprises an access control circuit 211 connected to the memory interface 204 and intermediate buffer interface 205, an FFT circuit 212, a data bus 213 interconnecting the access control circuit 211 and the FFT circuit 212, an N-bit counter 214, an N-bit register 215, and a comparator 216.

When the access control circuit 211 receives an FFT start signal Ss, it reads the data for one vertical line in a sub-area from the memory 1 through the memory interface 204, sends the FFT circuit 212 a data ready signal Sr211, and sends the read data D204 to the FFT circuit 212 on the data bus 213.

The FFT circuit 212 performs a one-dimensional FFT on the read data D204 and, upon the completion of this transform, sends a one-dimensional FFT completion signal Sd212 to the access control circuit 211. The access control circuit 211 responds by retrieving M1-th and M2-th values in the resulting transformed data D205, corresponding to the selected two horizontal lines from the FFT circuit 212, via the data bus 213 and writes the two retrieved data values into the internal buffer 203 via the intermediate buffer interface 205 as first transformed data.

The access control circuit 211 and FFT circuit 212 repeat the above operations for all vertical lines in the sub-area; then the access control circuit 211 outputs a vertical FFT completion signal Sd.

The N-bit counter 214 counts occurrences of the vertical FFT completion signal Sd as in the first embodiment and outputs a count value C214.

The N-bit register 215 stores and outputs a value C215 corresponding to the number of sample points (pixels) per vertical line in the sub-area. For a 32×32-pixel sub-area, the N-bit register 115 stores the value ‘32’.

The comparator 216 compares the count value C214 output by the N-bit counter 214 with the value C215 stored in the N-bit register 215. If the compared data match, the comparator 216 asserts a match signal Sm216. Otherwise, the comparator 116 asserts a mismatch signal Sn216.

In response to either the match signal Sm216 or the mismatch signal Sn216, the access control circuit 211 begins rereading successive vertical lines of data from the memory 1. When the mismatch signal Sn116 is asserted, the access control circuit 211 increments M1 and M2 and rereads the data for the same sub-area, in order to obtain a new pair of horizontal lines of first transformed data. When the match signal Sm116 is asserted, the access control circuit 111 resets M1 and M2 and starts reading data for a new sub-area.

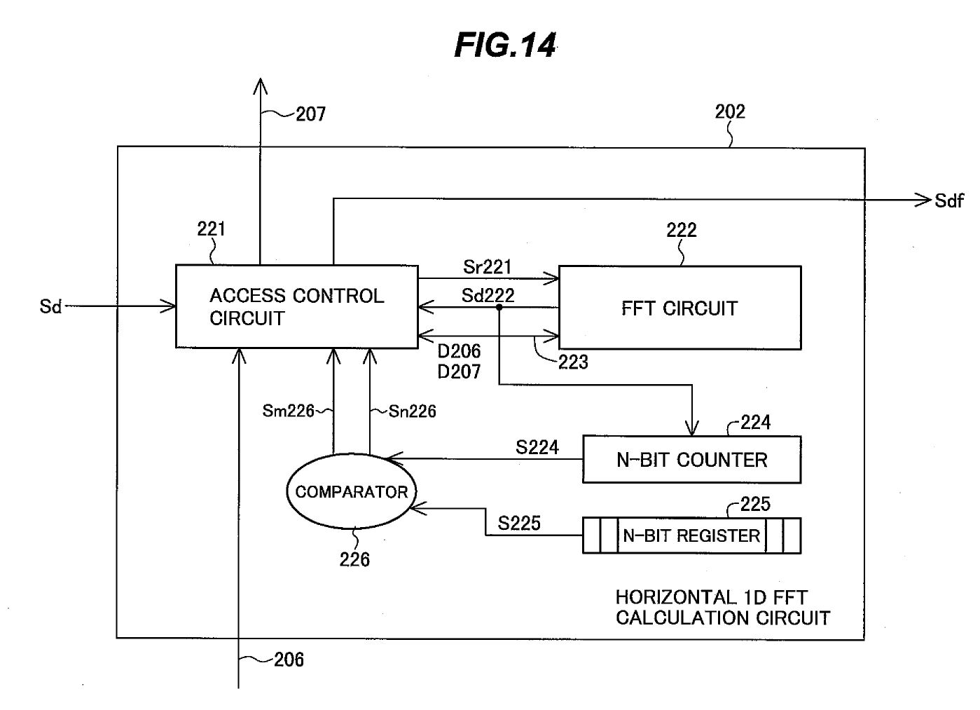

Referring to FIG. 14, the horizontal one-dimensional FFT calculation circuit 202 comprises an access control circuit 221 connected to the memory interface 207 and intermediate buffer interface 206, an FFT circuit 222, a data bus 223 interconnecting the access control circuit 221 and the FFT circuit 222, an N-bit counter 224, an N-bit register 225, and a comparator 226.

When the access control circuit 221 receives the vertical FFT completion signal Sd, it reads the data for two horizontal lines from the internal buffer 203 through the intermediate buffer interface 206, sends the FFT circuit 222 a data ready signal Sr221, and sends the read data D206 to the FFT circuit 222 on the data bus 223.

The FFT circuit 222 executes a horizontal one-dimensional FFT on each horizontal line of data D206 read from the internal buffer 203 and, upon the completion of these transforms, sends a one-dimensional FFT completion signal Sd222 to the access control circuit 221. When the access control circuit 221 receives the one-dimensional FFT completion signal Sd222, it retrieves all of the resulting second transformed data D207 via the data bus 223 and writes the second transformed data for the two horizontal lines into the memory 1 via the memory interface 207 as two-dimensional FFT output data for the M1-th and M2-th horizontal line.

The N-bit counter 224 is an up-counter that counts occurrences of the horizontal one-dimensional FFT completion signal Sd222 and outputs a count value C224.

The N-bit register 225 stores and outputs a value C225 corresponding to half the number of horizontal lines per sub-area. For a 32×32-pixel sub-area, the N-bit register 115 stores the value ‘16’.

The comparator 226 compares the count value C224 output by the N-bit counter 224 with the value C225 stored in the N-bit register 225. If the compared data match, the comparator 226 asserts a match signal Sm226. Otherwise, the comparator 226 asserts a mismatch signal Sn226.

When the mismatch signal Sn226 is asserted, the access control circuit 221 takes no particular action but simply waits for the next vertical FFT completion signal Sd from the vertical one-dimensional FFT calculation circuit 201. (If the values of M1 and M2 are held separately in the two access control circuits 211, 221, however, access control circuit 221 increments its internally held M1 and M2 values at this point.) When the match signal Sm126 is asserted, the access control circuit 221 outputs a two-dimensional FFT completion signal Sdf (and resets M1 and M2 if necessary).

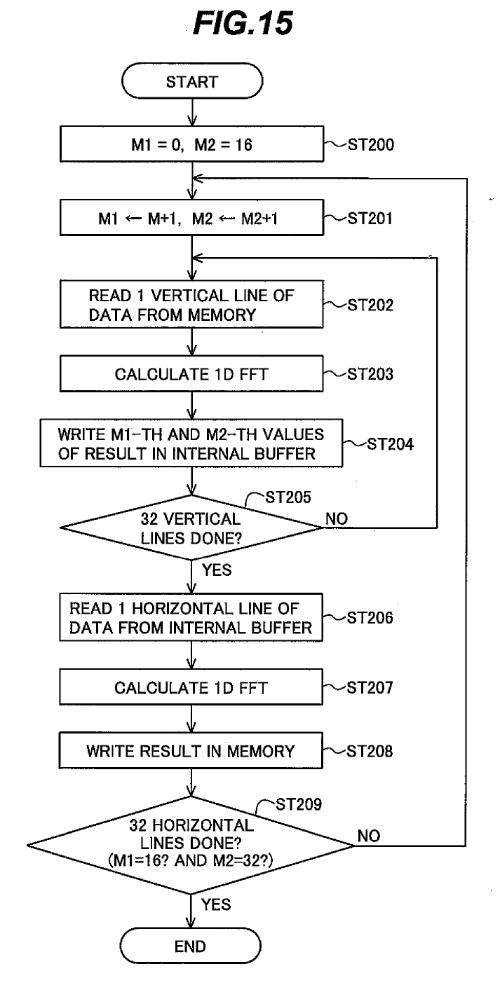

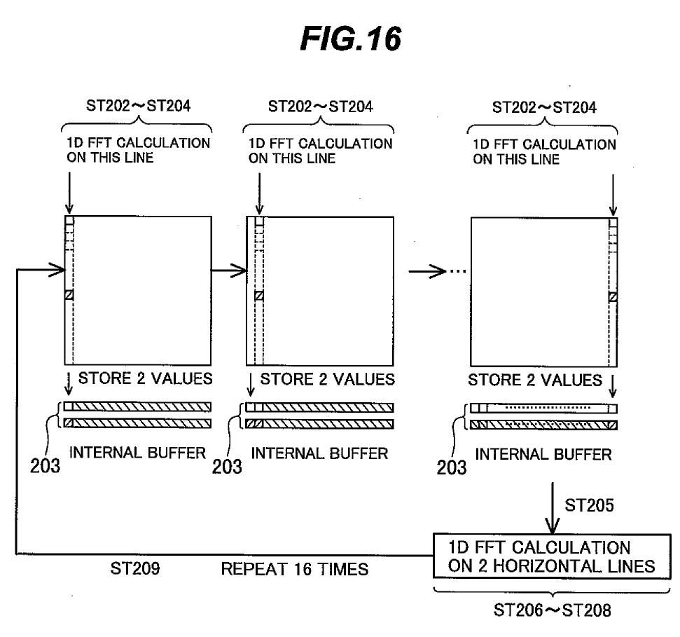

The operation of the two-dimensional FFT calculation apparatus 200 in the second embodiment will be described with reference to FIGS. 15 and 16.

As shown in FIG. 15, to begin the processing of a sub-area, the vertical one-dimensional FFT calculation circuit 201 initializes the numbers M1 and M2 to values of zero and sixteen, respectively (step ST200) and then increments each of these numbers M1, M2 by one (step ST201). Next, the data for one vertical line are read from the memory 1 (step ST202) and a one-dimensional FFT is executed on the one vertical line to generate the first transformed data (step ST203), after which the M1-th and M2-th transformed data values (in this case, M1=1 and M2=17) are selected from the first transformed data and written into the internal buffer 203 (step ST204). Next, the vertical one-dimensional FFT calculation circuit 201 executes the processes in steps ST202 to ST204 again repeatedly until these processes have been repeated thirty-two times (corresponding to the number of sample points in the horizontal direction of the sub-area 12), changing the vertical line each time (step ST205). At the end of these repetitions, the internal buffer 203 holds 64 values representing the first transformed data for the first and seventeenth horizontal lines.

Next, the horizontal one-dimensional FFT calculation circuit 202 reads the first transformed data from the internal buffer 203 (step ST206), executes a one-dimensional FFT on the two horizontal lines (step ST207), and writes the resulting second transformed data into memory 1 (step ST208).

Next, the vertical one-dimensional FFT calculation circuit 201 and horizontal one-dimensional FFT calculation circuit 202 repeat the processes in steps ST201 to ST208 for fifteen more pairs of horizontal lines (M1=2 to 16 and M2=18 to 32, making sixteen repetitions in total (step ST109). At the end of these repetitions, the memory 1 holds second transformed data for a matrix of data points arranged in thirty-two vertical and thirty-two horizontal lines. This completes the two-dimensional FFT for one sub-area 12.

Like the first embodiment, the second embodiment requires considerably less than the conventional amount of internal buffer space. In the second embodiment, the necessary internal buffer space is reduced by a factor of sixteen.

In addition, the second embodiment (or the equivalent two-dimensional FFT calculation method) requires only about half as much computation as the first embodiment, since the vertical FFT computations are repeated only half as many times.

In a variation of the second embodiment, the size of the internal buffer 203 is doubled to provide space for two data planes. For example, the internal buffer 203 may have enough space to store data for 128 sample points (corresponding to 32 vertical lines×2 horizontal lines×2 planes). The horizontal one-dimensional FFT calculation circuit 202 processes the data stored in one plane while the vertical one-dimensional FFT calculation circuit 201 is calculating and storing data in the other plane. This enables steps ST206 to ST208 in FIG. 15 to be carried out during one or more repetitions of steps ST202 to ST204; that is, the horizontal and vertical FFT calculations can be pipelined. The enlarged internal buffer 203 is still much smaller than the conventional internal buffer.

Those skilled in the art will recognize that further variations are possible within the scope of the invention, which is defined in the appended claims.

What is claimed is:

1. A method of executing a two-dimensional fast Fourier transform on first data representing a two-dimensional array of sample points arranged in first lines extending in a first direction and second lines extending in a second direction, intersecting the first lines, the method comprising the steps of:
(a) executing a one-dimensional fast Fourier transform on the first data for each first line to generate first transformed data, selecting the first transformed data for a first predetermined number of specified positions in each first line, and storing the selected first transformed data in an internal buffer;
(b) executing a one-dimensional fast Fourier transform on the first transformed data stored in the internal buffer to obtain second transformed data for the first predetermined number of second lines and outputting second transformed data; and
(c) repeating steps (a) and (b) with different specified positions until the one-dimensional fast Fourier transform has been performed on all of the second lines; wherein
each first line includes a second predetermined number of sample points; and
the first predetermined number is less than the second predetermined number.

2. The method of claim 1, further comprising:
replacing the first data with new first data; and
repeating said steps (a), (b), and (c), using the new first data.

3. The method of claim 1, wherein the first predetermined number is one.

4. The method of claim 1, wherein the first predetermined number is an integer that evenly divides the second predetermined number.

5. The method of claim 1, wherein the internal buffer has space to hold at least twice as much data as the first transformed data for the first predetermined number of second lines; and
during each non-final execution of said step (b), the one-dimensional fast Fourier transform in said step (a) is repeated on the first data for at least one first line to generate at least part of the first transformed data to be used in a following repetition of said step (b).

6. The method of claim 5, wherein during a final execution of said step (b), said step (a) is repeated on at least one first line of new first data, after which said steps (a), (b), and (c) are continued, using the new first data.

7. Apparatus for executing a two-dimensional fast Fourier transform on first data representing a two-dimensional array of sample points arranged in first lines extending in a first direction and second lines extending in a second direction, intersecting the first lines, the apparatus comprising:
an internal buffer;
a first computational circuit for executing a one-dimensional fast Fourier transform on the first data on each first line to generate first transformed data, selecting the first transformed data for a first predetermined number of specified positions in each first line, and storing the selected first transformed data in an internal buffer; and
a second computational circuit for executing a one-dimensional fast Fourier transform on the first transformed data stored in the internal buffer to obtain second transformed data for the first predetermined number of second lines and outputting the second transformed data; wherein
the first computational circuit repeatedly executes the one-dimensional fast Fourier transform on all the first data, changing the specified positions at each repetition, and the second computational circuit repeatedly executes the one-dimensional fast Fourier transform on the resulting first transformed data, until the one-dimensional fast Fourier transform has been performed on all of the second lines;
each first line includes a second predetermined number of sample points; and
the first predetermined number is less than the second predetermined number.

8. The apparatus of claim 7, wherein the first data are replaced with new first data and the first and second computational circuits execute the one-dimensional fast Fourier transform on the new first data to carry out a two-dimensional fast Fourier transform on the new first data.

9. The apparatus of claim 7, wherein the first predetermined number is one.

10. The apparatus of claim 7, wherein the first predetermined number is an integer that evenly divides the second predetermined number.

11. The apparatus of claim 7, wherein the internal buffer has space to hold at least twice as much data as the first transformed data for the first predetermined number of second lines, and while the second computational circuit is performing the one-dimensional fast Fourier transform on the first transformed data for one set of the first predetermined number of second lines, the first computational circuit repeats the one-dimensional fast Fourier transform on the first data for at least one of the first lines to obtain at least part of the first transformed data for another set of the first predetermined number of second lines.

12. The apparatus of claim 7, wherein the apparatus constitutes at least part of a semiconductor integrated circuit.
